(19) United States
(12) Patent Application Publication
(10) Pub. No.: US 2024/0114205 A1
(43) Pub. Date: Apr. 4, 2024

(54) CONFERENCING SESSION QUALITY MONITORING

(71) Applicant: Microsoft Technology Licensing, LLC, Redmond, WA (US)

(72) Inventor: Ryen William WHITE, Woodinville, WA (US)

(73) Assignee: Microsoft Technology Licensing, LLC, Redmond, WA (US)

(21) Appl. No.: 17/976,436

(22) Filed: Oct. 28, 2022

Related U.S. Application Data
(60) Provisional application No. 63/411,426, filed on Sep. 29, 2022.

(51) Int. Cl. H04N 21/4425; G06F 3/14; H04N 21/433; H04N 21/4788

(52) U.S. Cl. CPC H04N 21/4425; G06F 3/1462; H04N 21/4334; H04N 21/4788

(57) ABSTRACT

A method for monitoring quality of a conferencing session between a plurality of participant devices is described. One or more data streams of the conferencing session are monitored. Presenter contextual information is determined for media transmitted over the one or more data streams by a presenter device of the plurality of participant devices. A mismatch is identified between the presenter contextual information and a first participant contextual information for a first participant device of the plurality of participant devices. A mismatch notification is provided to the presenter device for an identified mismatch.

### CROSS REFERENCES TO RELATED APPLICATIONS

This application claims the benefit of U.S. Provisional Patent Application No. 63/411,426, entitled “Conferencing Session Quality Monitoring,” filed on Sep. 29, 2022, which is hereby incorporated herein by reference in its entirety.

### BACKGROUND

There are many common challenges that affect individual and team productivity on conference calls. Some challenges affect those connected to audio-visual functionality, such as a video conference, where a user is speaking but not being heard by others or refers to slides that are not yet shown or shared. These challenges may occur due to external constraints on the system (e.g., low network bandwidth), user errors (e.g., accidental mute), or software bugs or other issues with communication software that host the video conference. There are also scenarios when a user simply wants to know whether they can be seen and/or heard, or whether other participants on a call can see their slides or their shared screen. Current approaches to handling these challenges rely upon other participants to point out problems or a presenter proactively seeking confirmation from the other participants, but these solutions take time away from productive conversation and reduce an overall quality of the conference call.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to monitoring quality of a conferencing session.

In one aspect, a method for monitoring quality of a conferencing session between a plurality of participant devices is provided. The method comprises monitoring one or more data streams of the conferencing session; determining presenter contextual information for media transmitted over the one or more data streams by a presenter device of the plurality of participant devices; identifying a mismatch between the presenter contextual information and a first participant contextual information for a first participant device of the plurality of participant devices; and providing a mismatch notification to the presenter device for an identified mismatch.

In another aspect, a method for training a conference system is provided. The method comprises: monitoring data streams of a conferencing session between a plurality of participant devices, the data streams having one or more of an audio component, a video component, or a shared content component; determining presenter contextual information for first media transmitted over the data streams by a presenter device of the plurality of participant devices; determining first participant contextual information for second media received by a first participant device of the plurality of participant devices; labeling first segments of the data streams according to the presenter contextual information and second segments of the data streams according to the first participant contextual information; and training a machine learning model to provide mismatch notifications based on the labeled first segments and the labeled second segments where overlapping portions of the labeled first segments and the labeled second segments have different labels.

In yet another aspect, a system for monitoring quality of a conferencing session between a plurality of participant devices is provided. The system comprises a data stream processor configured to monitor one or more data streams of the conferencing session. The system further comprises a first context processor configured to: determine presenter contextual information for media transmitted over the one or more data streams by a presenter device of the plurality of participant devices, identify a mismatch between the presenter contextual information and a first participant contextual information for a first participant device of the plurality of participant devices, and provide a mismatch notification to the presenter device for an identified mismatch.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of a conference system for a conferencing session, according to an example embodiment.

FIG. 2 shows a block diagram of data streams for a conferencing session, according to an example embodiment.

FIG. 3 shows a diagram of an example notification for a conferencing session, according to an example embodiment.

FIG. 4 shows a diagram of another example notification for a conferencing session, according to an example embodiment.

FIG. 5 shows a flowchart of an example method of monitoring quality of a conferencing session between a plurality of participant devices, according to an example embodiment.

FIG. 6 shows a flowchart of another example method of training a conferencing system, according to an example embodiment.

FIG. 7 is a block diagram illustrating example physical components of a computing device with which aspects of the disclosure may be practiced.

FIG. 8 is a simplified block diagram of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various aspects of monitoring quality of a conferencing session and training a conference system that supports conferencing sessions. In some examples, a processor monitors data streams, such as audio or video output streams, from a presenter device on a conferencing session and, based on feedback from participant devices, may provide a notification to the presenter device when one or more of the data streams are either not received or are inconsistent with each other. For example, one notification provides feedback to the presenter device when participant devices cannot hear an audio stream (e.g., when a presenter is speaking while a mute function is activated). As another example, another notification provides feedback to the presenter device when participant devices cannot see shared content from the presenter device (e.g., when the presenter forgets to share their screen or shares a wrong document). In some examples, the system is configured to propose remediation strategies for handling identified problems. For example, the system may prompt a user to unmute a microphone, turn to a particular page in a shared document, disable video to conserve bandwidth, etc.

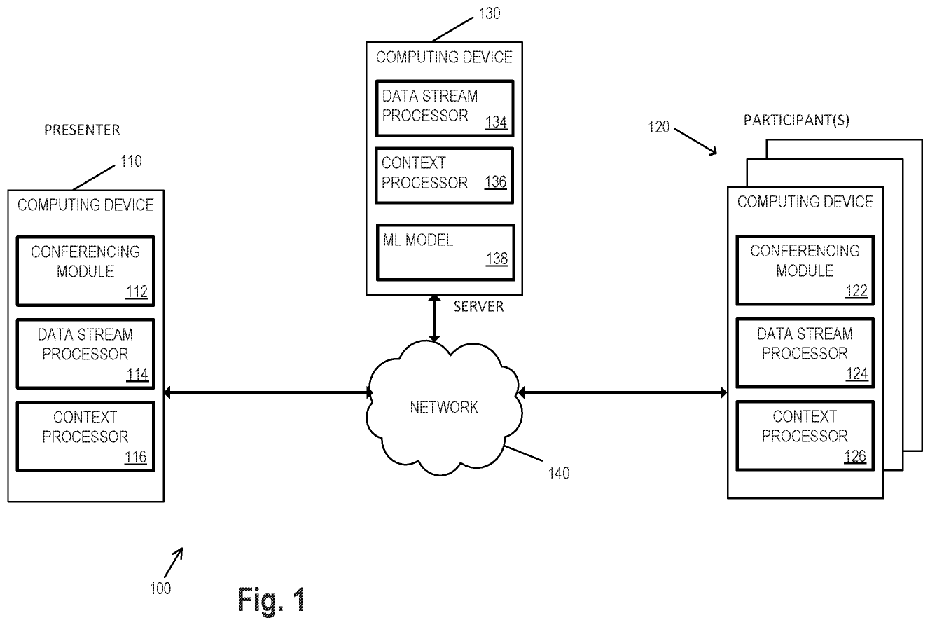

This and many further aspects for a computing device are described herein. For instance, FIG. 1 shows a block diagram of an example of a conference system 100 for a conferencing session, according to an example aspect. The conference system 100 comprises various computing devices 110, 120, and 130 that may be used by participants of a conferencing session, a host of the conferencing session, or by both a host and a participant of the conferencing session. In the embodiment shown in FIG. 1, the computing device 110 is used by a presenter (i.e., one of the participants who is providing media to the other participants, for example, by sharing content, video, or speaking), the computing device 130 is configured as a host for the conferencing session (e.g., by relaying and/or processing data streams among the participants), and one or more instances of computing device 120 are used by participants of the conferencing session.

Computing device 110 may be any type of computing device, including a mobile computer or mobile computing device (e.g., a Microsoft® Surface® device, a laptop computer, a notebook computer, a smartphone, a tablet computer such as an Apple iPad™, a netbook, etc.), or a stationary computing device such as a desktop computer or PC (personal computer). In some aspects, computing device 110 is a cable set-top box, streaming video box, or console gaming device. Computing device 110 may be configured to execute one or more software applications (or “applications”) and/or services and/or manage hardware resources (e.g., processors, memory, etc.), which may be utilized by users of the computing device 110.

The computing device 110 comprises a conferencing module 112, a data stream processor 114, and a context processor 116. In some aspects, computing device 120 is similar to computing device 110 (e.g., a mobile computer, laptop, etc.) and comprises a conferencing module 122, a data stream processor 124, and a context processor 126, generally corresponding to the conferencing module 112, the data stream processor 114, and the context processor 116, respectively.

The computing device 130 may include a data stream processor 134, a context processor 136, and a machine learning model 138. The data stream processor 134 and the context processor 136 may generally correspond to the data stream processor 114 and the context processor 116, respectively. In some examples, the computing device 130 is a network server, cloud server, or other suitable network device.

The conferencing module 112 (and conferencing module 122) generally provides a conferencing feature to users of the computing device 110. The conferencing feature supports taking part in conferencing sessions, such as conference call sessions, video call sessions, collaborative sessions, etc. The conferencing module 112 may be implemented as a software program (e.g., Microsoft Teams, Zoom, WebEx), a hardware-based circuit or processor, or a combination thereof. The conferencing module 112 comprises, or communicates with, one or more of an image sensor or camera, a microphone, speakers, a user interface (e.g., keyboard, mouse, buttons) that facilitate interaction with the conferencing feature. The conferencing module 112 may be configured to generate one or more data streams having various components, such as an audio component (e.g., an audio signal or transcript of words or sounds within an audio signal), video component (e.g., pixel information for displaying a video), or content sharing component (e.g., information for sharing a document, application, screen, etc.), and transmit the data streams to the computing devices 120 or 130. A user of the computing device 110 may select or provide media for transmission over the data streams, for example, by speaking into the microphone, appearing in front of a webcam, or interacting with a document to be shared with the participants. In some examples, the conferencing module 112 generates a single data stream that includes the audio component, video component, and shared content component. In other examples, the conferencing module 112 generates two or more data streams with separate components. As one example, a first data stream includes audio and a second data stream includes video and shared content. As another example, a first data stream includes audio and video and a second data stream includes shared content. In still other examples, a separate data stream is used for each of the audio, video, and shared content components.

The data stream processor 114 (and data stream processor 124 and 134) is configured to monitor the data streams generated by the conferencing modules 112 and 122. In some examples, the data stream processor 114 separates or extracts the audio, video, or shared content components from the data streams. The data stream processor 114 may then monitor the components separately, provide the components to other processors (e.g., context processors 116, 126, or 136), or perform other suitable processing.

The context processor 116 (and context processors 126 and 136) is configured to determine contextual information based on the data streams from the data stream processor 114. Advantageously, contextual information for the system 100 may be generated or provided by any of the presenter (computing device 110), participants (computing device 120), or host (computing device 130), in various aspects. The contextual information may then be provided to a suitable context processor for providing notifications to a corresponding user. The contextual information may include an audio status for an audio component, for example, one or more of a volume or signal level, presence or absence of a signal that meets a predetermined threshold (e.g., exceeding a level of background noise), a video status for a video component (e.g., whether a video signal is present or absent, whether a user is present in a video signal), or a shared content status (e.g., whether content has been shared, whether the content is visible, etc.).

Contextual information may be relevant to an entire conferencing session, such as a meeting title (e.g., “Financial Review 4Q 2022”), or may be relevant only to segments within the conferencing session. For example, contextual information based on content within a shared document may be relevant only while certain pages or slides are displayed. In some examples, the contextual information comprises keywords, names, or topics associated with the data streams. For example, when a presenter says a participant's name so the name is present within an audio component, the name may be added to the contextual information along with a timestamp of when the name was said. As another example, when a document is shared so its content is present within a shared content component, keywords within the document may be added to the contextual information. As yet another example, the context processor 116 may determine contextual information from chat messages within the conferencing session, for example, when a user types in “BRB” or “AFK” to indicate they have stepped away from their computer. In some examples, segments within the data streams are labeled with relevant contextual information, allowing for a comparison of contextual information

Generally, the context processor 116 may determine, or receive, contextual information for the presenter and one or more of the participants. Since each participant may send or receive media during a conferencing session, each participant may have a corresponding contextual information. In some scenarios, contextual information for participants may be different and are generally independent from each other, for example, one participant (a presenter) may have a mute feature activated so an audio component status may indicate a muted status. As another example, another participant may have a slow network connection and be unable to view a video component, so a video component status may indicate a dropped video feed. As yet another example, one participant may be viewing a first page of a shared document while another participant may be viewing a fifth page of the shared document.

The context processor 116 is configured to identify a mismatch between presenter contextual information (i.e., for the computing device 110) and a first participant contextual information (i.e., for the computing device 120). When a mismatch is identified, the context processor 116 may provide a mismatch notification to the presenter (computing device 110 via the conferencing module 112) for the identified mismatch. The mismatch notification may be a visual display, such as a pop-up, icon, or other element within a graphical user interface, an audio queue, a haptic feedback, or other suitable notification, in various aspects. Accordingly, when a presenter is speaking and providing audio to the conferencing module 112 (i.e., presenter contextual information indicates audio is present), but that audio is not received by other participants due to a mute feature (i.e., a first participant contextual information indicates an absence of audio), the context processor 116 may provide a notification to the presenter, for example, a user interface pop-up to propose an audio unmute action. In this way, a presenter does not need to ask other participants “can you hear me?” and await a response before proceeding with the conferencing session. In a similar example, the context processor 116 may indicate when other participants can see the presenter, which removes a reliance on hardware-based solutions, e.g., a webcam status LED. In yet another example, the context processor 116 may indicate when other participants can see shared content, such as a document (e.g., text document, spreadsheet, presentation or slide show, etc.), shared screen, or shared application, so the presenter does not need to ask other participants whether the shared content is visible.

In various aspects, media, components from the data streams, or contextual information for a conferencing session are provided to the machine learning model 138, for example, by the data stream processors 114, 124, or 134, or by the context processors 116, 126, or 136. Although only one machine learning model 138 is shown in FIG. 1, the computing device 130 may include one, two, three, or more machine learning models 138 that are trained for different tasks. In some aspects, the machine learning models 138 are integral with the context processor 136. The machine learning model 138 may be implemented as a deep learning model, transformer model, species distribution model, or a combination thereof. In some examples, multiple instances of the machine learning model 138 are provided within the conferencing system 100, for example, at the computing device 110 or the computing device 120.

Generally, the machine learning model 138 is configured to identify mismatches between the media, components, or contextual information. In other words, the machine learning model 138 processes the components (e.g., audio, video, or shared content components) or contextual information and flags inconsistencies between them. In various aspects, the machine learning model 138 is configured to flag an inconsistency between an audio component and a video component, between an audio component and a shared content component, or between a video component and a shared content component. In some aspects, the inconsistency occurs when a comparison of contextual information for participants fall below a relevance threshold (e.g., the context suggests the components are no longer relevant to each other). For example, when keywords within a displayed page of a shared document (shared content component) no longer match keywords that are being spoken (audio component), the machine learning model 138 may flag the inconsistency. The relevance threshold may be met when 50% of keywords match between the shared content component and the audio component, 30% of keywords match between the audio component and the video component, etc. In some aspects, specific keywords or phrases are weighted more heavily, such as keywords or phrases dealing with “pages” or “slides”. In some examples, the machine learning model 138 processes a video component to determine whether a participant appears to be confused, which may increase a likelihood of a mismatch.

Network 140 may comprise one or more networks such as local area networks (LANs), wide area networks (WANs), enterprise networks, the Internet, etc., and may include one or more of wired and/or wireless portions. Computing devices 110, 120, and 140 may include at least one wired or wireless network interface that enables communication with each other (or an intermediate device, such as a Web server or database server) via network 140. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 140 include a local area network (LAN), a wide area network (WAN), a personal area network (PAN), the Internet, and/or any combination thereof.

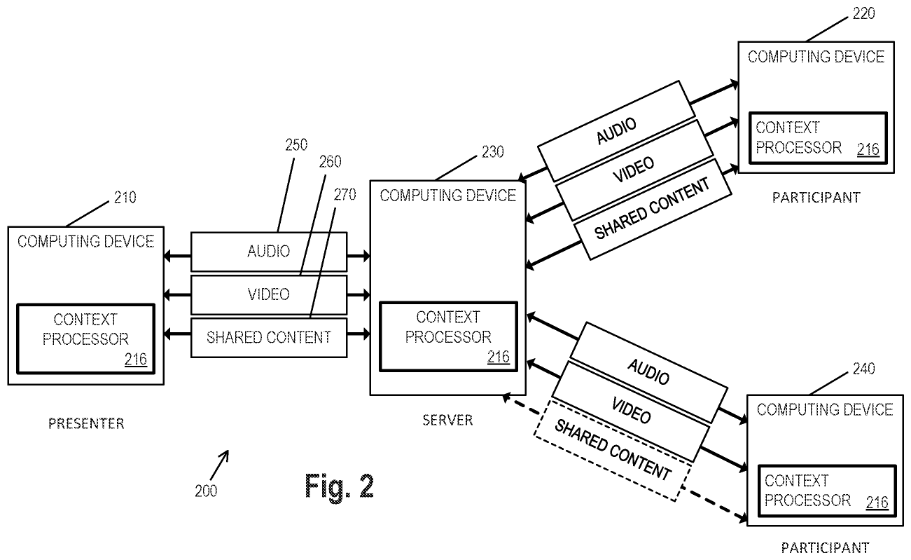

FIG. 2 shows a block diagram of data streams for a conferencing session 200, according to an example aspect. The conferencing session 200 is hosted by a server 230 and participants of the conferencing session 200 include a presenter 210, a participant 220, and a participant 240. The presenter 210, participant 220, and participant 240 may correspond to the computing device 110 or 120, in various aspects, and comprise an instance of a context processor 216 (e.g., similar to the context processor 116). The server 230 may correspond to the computing device 130, in various aspects, and comprise an instance of the context processor 216.

The conferencing session 200 comprises three data streams: an audio stream (or component) 250, a video stream (or component) 260, and a shared content stream (or component) 270. In the example shown in FIG. 2, the presenter 210 provides audio and video to the audio stream 250 and the video stream 260, respectively, using a webcam and further provides a spreadsheet to the shared content stream 270 (e.g., using a document sharing feature of the conferencing module 112). The audio, video, and spreadsheet are transmitted to the participant 220, but the spreadsheet is not able to be viewed by the participant 240 (shown by a dashed line for the shared content), for example, due to excessive packet loss. In this example, a presenter contextual information (generated by the context processor 216 of the presenter 210) indicates a presence of the audio, video, and shared content streams 250, 260, and 270, but the participant contextual information (generated by the context processor 216 of the participant 240) indicates a presence of only the audio and video streams 250 and 260. The context processor 216 of the presenter 210 may provide a notification to a user of the presenter 210, indicating that the spreadsheet is not able to be viewed by a user of the participant 240.

The context processor 216 may be configured to propose remediation strategies for handling identified problems. For example, the context processor 216 may prompt a user to unmute a microphone, turn to a particular page in a shared document, disable video to conserve bandwidth, rejoin the conferencing session, reshare content, etc. In some examples, the machine learning model 138 provides a ranked list of remediation options to the context processor 216 for communication to the user.

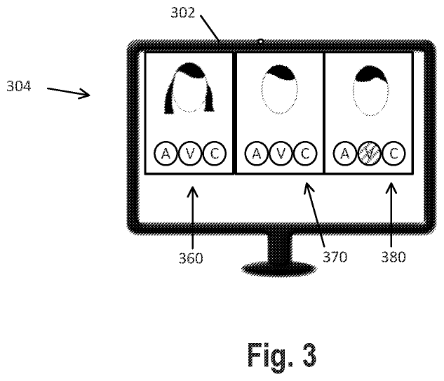

FIG. 3 shows a diagram of example notifications for a conferencing session, according to an example embodiment. As shown in FIG. 3, a display 302 of the computing device 110 provides a user interface 304 which may be generated by the conferencing module 112. The user interface 304 comprises panes 360, 370, and 380 for three participants of a conferencing session. Each of the panes 360, 370, and 380 includes an icon A, V, and C that indicate a status of an audio component, a video component, and a shared content component, respectively, for the conferencing session, along with a video component received by the computing device 110. In FIG. 3, the pane 380 indicates that the video component of the third participant is inactive by greying out the icon for the video component. In other examples, the notifications may be provided as colored icons, animations, or other suitable visual notifications.

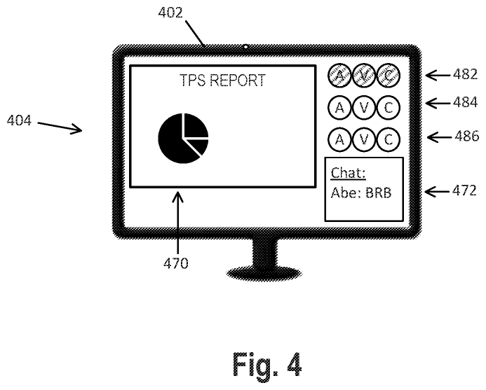

FIG. 4 shows a diagram of another example notification for a conferencing session, according to an example embodiment. As shown in FIG. 4, a display 402 of the computing device 110 provides a user interface 404 which may be generated by the conferencing module 112. The user interface 404 comprises a pane 470 for a shared document (shared content component), a pane 472 for a chat window (shared content component), and respective icon sets 482, 484, and 486 for three participants of the conferencing session. In FIG. 4, the icon set 482 for a first user, “Abe”, has been greyed out to indicate that the user is likely not viewing the conferencing session. For example, the context processor 116 may determine that the first user has left a computing device 120 based on the text chat of “BRB”, typically written to mean the user will “be right back” and from an absence of the first user within a captured image from a webcam of the computing device 120.

In some examples, the context processor 116 is configured to remove elements from the user interface 304 or 404 when no content mismatch is identified. For example, when each participant is able to see a video from the presenter, the context processor 116 may remove a selfie image of the presenter from the presenter's user interface. Removal of the user's image may improve the user's comfort during the conferencing session or increase space within the user interface for other content.

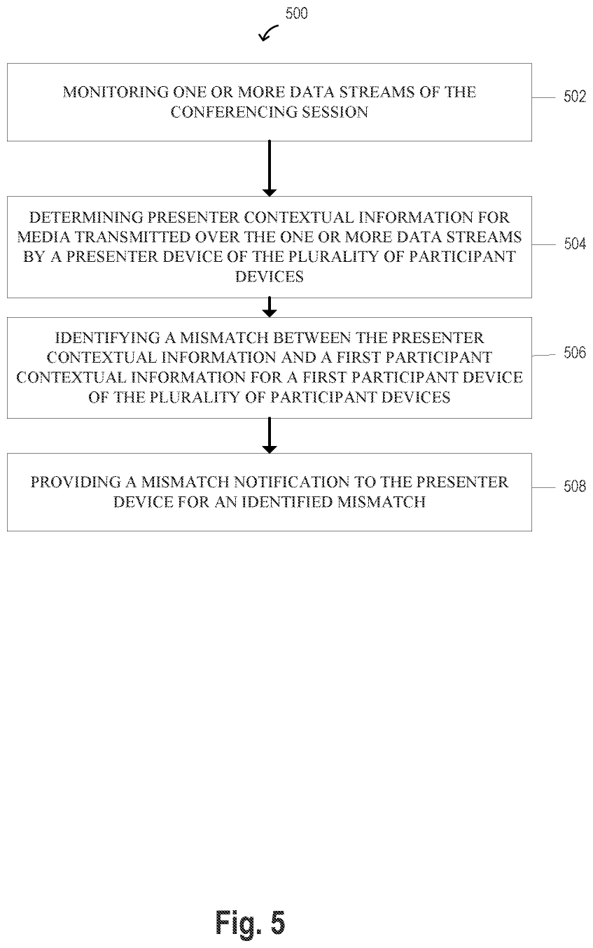

FIG. 5 shows a flowchart of an example method 500 of monitoring quality of a conferencing session between a plurality of participant devices, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 5. Steps may be performed serially, in a partially overlapping manner, or fully in parallel. Thus, the order in which steps of method 500 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 5 may be performed by the computing device 110 (e.g., via the conferencing module 112, the data stream processor 114, or the context processor 116), or other suitable computing device.

Method 500 begins with step 502. At step 502, one or more data streams of the conferencing session are monitored. The data streams may correspond to the data streams 250, 260, and 270, for example, and be monitored by the data stream processor 114, 124, or 134, for example. In some aspects, each of the data stream processors 114, 124, and 134 monitors the data streams.

At step 504, presenter contextual information is determined for media transmitted over the one or more data streams by a presenter device of the plurality of participant devices. In some examples, the context processor 116 of the computing device 110 determines the presenter contextual information. In some aspects, determining the presenter contextual information comprises one or more of determining a presenter audio status for an audio component of the conferencing session provided by the presenter device; determining a presenter video status for a video component of the conferencing session provided by the presenter device; or determining a presenter shared content status for a shared content component of the conferencing session provided by the presenter device.

At step 506, a mismatch is identified between the presenter contextual information and a first participant contextual information for a first participant device of the plurality of participant devices. For example, the context processor 216 may identify the mismatch between the presenter contextual information and the participant contextual information for the shared content component 270.

At step 508, a mismatch notification is provided to the presenter device for an identified mismatch. In one example, the context processor 216 provides the pane 380 with greyed out icon as the mismatch notification. In another example, the context processor 216 provides the icon set 482 with greyed out icons as the mismatch notification. In still other examples, the context processor 116, 126, 136, or 216 displays an element within a graphical user interface or provides an audio queue, a haptic feedback, or other suitable notification.

In some examples, the method 500 further comprises receiving the first participant contextual information from the first participant device, wherein the first participant contextual information includes one or more of a participant audio status of the audio component, a participant video status of the video component, or a participant shared content status of the shared content component.

In some examples, identifying the mismatch comprises generating the mismatch notification when: the presenter audio status indicates a presence of the audio component and the participant audio status indicates an absence of the audio component, the presenter video status indicates a presence of the video component and the participant video status indicates an absence of the video component, or the presenter shared content status indicates a presence of the shared content component and the participant shared content status indicates an absence of the shared content component.

In some examples, the conferencing session has multiple participants and at least one presenter sharing data including: a first audio component and the participant audio status indicates an absence of the first audio component, a first video component and the participant video status indicates an absence of the first video component, or a first shared content component and the participant shared content status indicates an absence of the first shared content component. The shared content component may include one or more of a screen sharing session, app sharing session, collaborative tool sharing session, or document sharing session. In some examples, the first shared content comprises a document and identifying the mismatch comprises: labeling pages of the document with keywords based on content within the document; providing the labeled pages and the first audio component to the machine learning model. In some examples, the first audio component is a transcript of an audio signal captured during the conferencing session.

In some examples, identifying the mismatch comprises generating the mismatch notification when a machine learning model flags an inconsistency between: the first audio component and the first video component, the first audio component and the first shared content component, or the first video component and the first shared content component.

In some aspects, the method 500 further comprises receiving one or more of the first audio component, the first video component, or the first shared content component from the at least one presenter; and sending the one or more of the first audio component, the first video component, or the first shared content component to the multiple participants.

In some aspects, the method 500 further comprises generating the mismatch notification to identify one or more remediation options for the identified mismatch. Examples of remediation options may include one or more of unmuting a microphone (e.g., “Unmute your headset using the on/off slider”), turning to a particular page in a shared document (e.g., “Turn to slide 7”), disable video to conserve bandwidth, rejoin the conferencing session, reshare content.

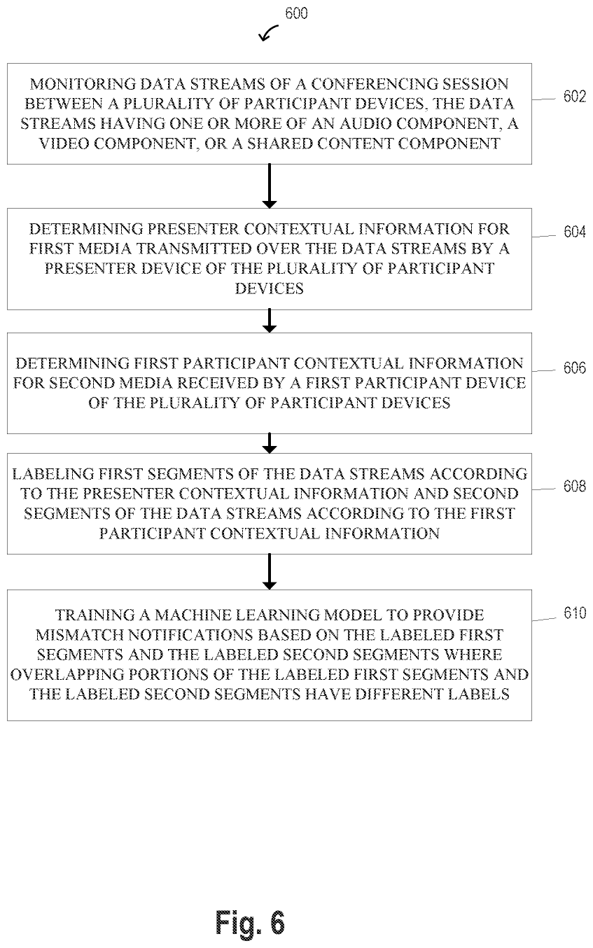

FIG. 6 shows a flowchart of an example method 600 of training a conference system, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 6. Steps may be performed serially, in a partially overlapping manner, or fully in parallel. Thus, the order in which steps of method 600 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 6 may be performed by the computing device 110 (e.g., via the context processor 116), or other suitable computing device.

Method 600 begins with step 602. At step 602, data streams of a conferencing session are monitored between a plurality of participant devices, the data streams having one or more of an audio component, a video component, or a shared content component.

At step 604, presenter contextual information is determined for first media transmitted over the data streams by a presenter device of the plurality of participant devices.

At step 606, first participant contextual information is determined for second media received by a first participant device of the plurality of participant devices.

At step 608, first segments of the data streams are labeled according to the presenter contextual information and second segments of the data streams are labeled according to the first participant contextual information.

At step 610, a machine learning model is trained to provide mismatch notifications based on the labeled first segments and the labeled second segments where overlapping portions of the labeled first segments and the labeled second segments have different labels. In various examples, the mismatch notifications comprise one or more of: a first notification to the presenter device that indicates a proposed page jump for the shared content component; a second notification to the presenter device that indicates a proposed alternate path for the one or more of the audio component, the video component, or the shared content component; a third notification to the presenter device that indicates a proposed document to be shared via the shared content component; or a fourth notification to the first participant device that indicates a proposed audio unmute action.

In some examples, the method 600 further comprises: receiving the presenter contextual information from the presenter device, wherein the presenter contextual information is generated by the presenter device based on the data streams; and receiving the participant contextual information from the first participant device, wherein the participant contextual information is generated by the first participant device based on the data streams. In one example, the data streams of the conferencing session are stored within a video recording of the conferencing session and the method 600 further comprises separating the one or more of the audio component, the video component, or the shared content component into independent streams using the machine learning model.

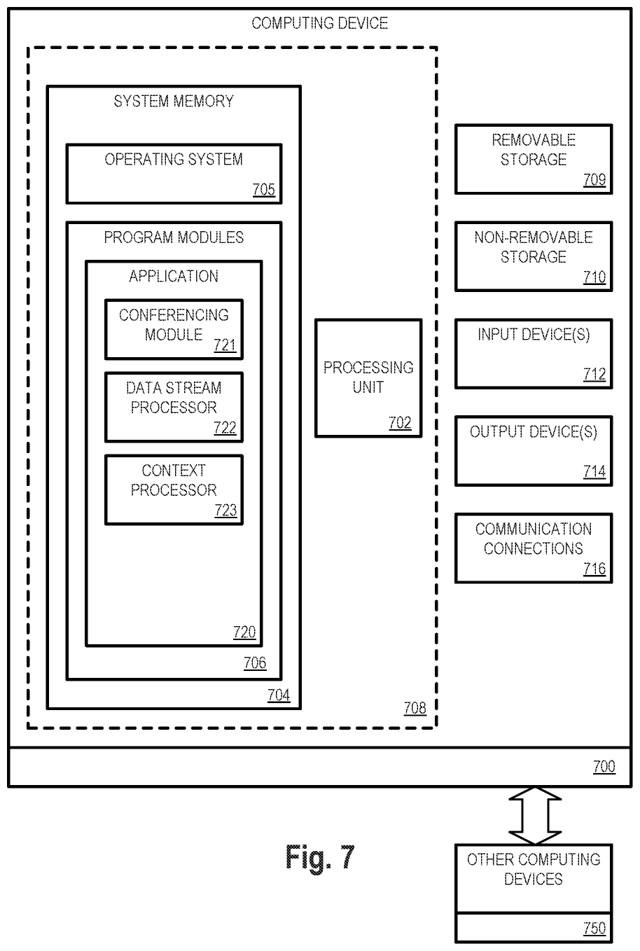

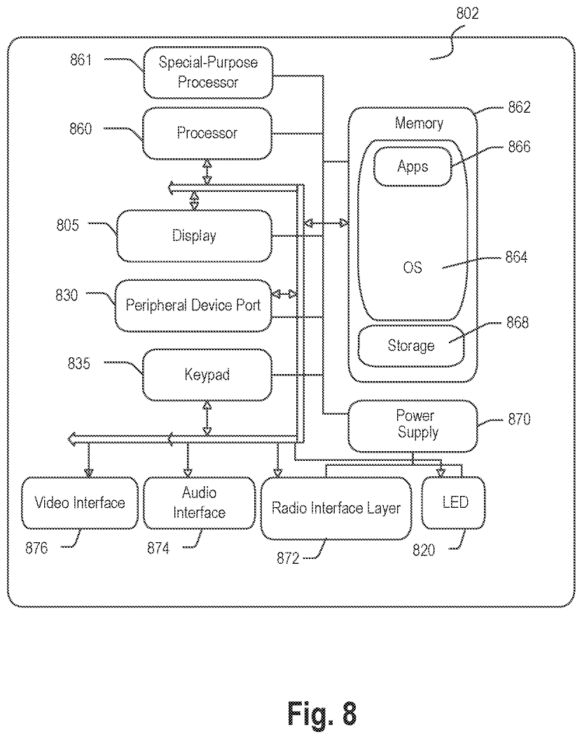

FIGS. 7 and 8 and the associated descriptions provide a discussion of a variety of operating environments in which aspects of the disclosure may be practiced. However, the devices and systems illustrated and discussed with respect to FIGS. 7 and 8 are for purposes of example and illustration and are not limiting of a vast number of computing device configurations that may be utilized for practicing aspects of the disclosure, as described herein.

FIG. 7 is a block diagram illustrating physical components (e.g., hardware) of a computing device 700 with which aspects of the disclosure may be practiced. The computing device components described below may have computer executable instructions for implementing a conference system application 720 on a computing device (e.g., computing device 110, computing device 120, computing device 130), including computer executable instructions for conference system application 720 that can be executed to implement the methods disclosed herein. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories. The system memory 704 may include an operating system 705 and one or more program modules 706 suitable for running conference system application 720, such as one or more components with regard to FIGS. 1 and 2 and, in particular, conferencing module 721 (e.g., corresponding to conferencing module 112), data stream processor 722 (e.g., corresponding to data stream processor 114), and context processor 723 (e.g., corresponding to context processor 116).

The operating system 705, for example, may be suitable for controlling the operation of the computing device 700. Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., conference system application 720) may perform processes including, but not limited to, the aspects, as described herein. Other program modules that may be used in accordance with aspects of the present disclosure, and in particular for monitoring quality of a conferencing session, may include conferencing module 112, data stream processor 722, and context processor 723.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIG. 8 illustrates a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. FIG. 8 is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as email or other messages used by an email application, and the like. A synchronization application (not shown) also resides on the system 802 and is programmed to interact with a corresponding synchronization application resident on a host computer to keep the information stored in the non-volatile storage area 868 synchronized with corresponding information stored at the host computer.

The system 802 has a power supply 870, which may be implemented as one or more batteries. The power supply 870 may further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via an audio transducer 825 (e.g., audio transducer 825 illustrated in FIG. 8). In the illustrated embodiment, the visual indicator 820 is a light emitting diode (LED) and the audio transducer 825 may be a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of peripheral device 830 (e.g., on-board camera) to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8 by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network. Similarly, such data/information may be readily transferred between computing devices for storage and use according to well-known data/information transfer and storage means, including electronic mail and collaborative data/information sharing systems.

As should be appreciated, FIGS. 7 and 8 as disclosed herein are described for purposes of illustrating the present methods and systems and are not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for monitoring quality of a conferencing session between a plurality of participant devices, the method comprising:
monitoring one or more data streams of the conferencing session;
determining presenter contextual information for media transmitted over the one or more data streams by a presenter device of the plurality of participant devices;
identifying a mismatch between the presenter contextual information and a first participant contextual information for a first participant device of the plurality of participant devices; and
providing a mismatch notification to the presenter device for an identified mismatch.

2. The method of claim 1, wherein determining the presenter contextual information comprises one or more of:
determining a presenter audio status for an audio component of the conferencing session provided by the presenter device;
determining a presenter video status for a video component of the conferencing session provided by the presenter device; or
determining a presenter shared content status for a shared content component of the conferencing session provided by the presenter device.

3. The method of claim 2, the method further comprising receiving the first participant contextual information from the first participant device, wherein the first participant contextual information includes one or more of a participant audio status of the audio component, a participant video status of the video component, or a participant shared content status of the shared content component.

4. The method of claim 3, wherein identifying the mismatch comprises generating the mismatch notification when:
the presenter audio status indicates a presence of the audio component and the participant audio status indicates an absence of the audio component,
the presenter video status indicates a presence of the video component and the participant video status indicates an absence of the video component, or
the presenter shared content status indicates a presence of the shared content component and the participant shared content status indicates an absence of the shared content component.

5. The method of claim 3, wherein the conferencing session has multiple participants and at least one presenter sharing data including:
a first audio component and the participant audio status indicates an absence of the first audio component,
a first video component and the participant video status indicates an absence of the first video component, or
a first shared content component and the participant shared content status indicates an absence of the first shared content component.

6. The method of claim 5, wherein the shared content component comprises one or more of a screen sharing session, app sharing session, collaborative tool sharing session, or document sharing session.

7. The method of claim 5, wherein identifying the mismatch comprises generating the mismatch notification when a machine learning model flags an inconsistency between:
the first audio component and the first video component,
the first audio component and the first shared content component, or
the first video component and the first shared content component.

8. The method of claim 7, wherein the first shared content comprises a document and identifying the mismatch comprises:
labeling pages of the document with keywords based on content within the document; and
providing the labeled pages and the first audio component to the machine learning model.

9. The method of claim 3, the method further comprising:
generating the mismatch notification to identify one or more remediation options for the identified mismatch.

10. A method for training a conference system, the method comprising:
monitoring data streams of a conferencing session between a plurality of participant devices, the data streams having one or more of an audio component, a video component, or a shared content component;
determining presenter contextual information for first media transmitted over the data streams by a presenter device of the plurality of participant devices;
determining first participant contextual information for second media received by a first participant device of the plurality of participant devices;
labeling first segments of the data streams according to the presenter contextual information and second segments of the data streams according to the first participant contextual information; and
training a machine learning model to provide mismatch notifications based on the labeled first segments and the labeled second segments where overlapping portions of the labeled first segments and the labeled second segments have different labels.

11. The method of claim 10, the method further comprising:
receiving the presenter contextual information from the presenter device, wherein the presenter contextual information is generated by the presenter device based on the data streams; and
receiving the participant contextual information from the first participant device, wherein the participant contextual information is generated by the first participant device based on the data streams.

12. The method of claim 10, wherein the data streams of the conferencing session are stored within a video recording of the conferencing session, the method further comprising:
separating the one or more of the audio component, the video component, or the shared content component into independent streams using the machine learning model.

13. The method of claim 10, wherein the mismatch notifications comprise one or more of:
a first notification to the presenter device that indicates a proposed page jump for the shared content component;
a second notification to the presenter device that indicates a proposed alternate path for the one or more of the audio component, the video component, or the shared content component;
a third notification to the presenter device that indicates a proposed document to be shared via the shared content component; or
a fourth notification to the first participant device that indicates a proposed audio unmute action.

14. A system for monitoring quality of a conferencing session between a plurality of participant devices, the system comprising:
a data stream processor configured to monitor one or more data streams of the conferencing session;
a first context processor configured to:
determine presenter contextual information for media transmitted over the one or more data streams by a presenter device of the plurality of participant devices,
identify a mismatch between the presenter contextual information and a first participant contextual information for a first participant device of the plurality of participant devices, and
provide a mismatch notification to the presenter device for an identified mismatch.

15. The system of claim 14, wherein the first context processor is configured to:
determine a presenter audio status for an audio component of the conferencing session provided by the presenter device;
determine a presenter video status for a video component of the conferencing session provided by the presenter device; and
determine a presenter shared content status for a shared content component of the conferencing session provided by the presenter device.

16. The system of claim 15, wherein the first context processor is configured to receive the first participant contextual information from the first participant device, wherein the first participant contextual information includes one or more of a participant audio status of the audio component, a participant video status of the video component, or a participant shared content status of the shared content component.

17. The system of claim 16, wherein the first context processor is configured to generate the mismatch notification when:
the presenter audio status indicates a presence of the audio component and the participant audio status indicates an absence of the audio component,
the presenter video status indicates a presence of the video component and the participant video status indicates an absence of the video component, or
the presenter shared content status indicates a presence of the shared content component and the participant shared content status indicates an absence of the shared content component.

18. The system of claim 16, wherein the conferencing session has multiple participants and at least one presenter sharing data including:
a first audio component and the participant audio status indicates an absence of the first audio component,
a first video component and the participant video status indicates an absence of the first video component, or
a first shared content component and the participant shared content status indicates an absence of the first shared content component.

19. The system of claim 18, wherein the shared content component comprises one or more of a screen sharing session, app sharing session, collaborative tool sharing session, or document sharing session.

20. The system of claim 18, the system further comprising the presenter device and the first participant device;
wherein the presenter device comprises the first context processor and the first participant device comprises a second context processor.
